(19) United States
(12) Patent Application Publication
(10) Pub. No.: US 2003/0142487 A1
(43) Pub. Date: Jul. 31, 2003

(54) Liquid crystal display device and backlight module thereof

(75) Inventor: Kuo-Shu Fan, Tainan County (TW)

Correspondence Address: SENNIGER POWERS LEAVITT AND ROEDEL, ONE METROPOLITAN SQUARE, 16TH FLOOR, ST LOUIS, MO, 63102, US

(73) Assignee: Chi Mei Optoelectronics Corp.

(21) Appl. No.: 10/205,429

(22) Filed: Jul. 25, 2002

(30) Foreign Application Priority Data
Jan. 29, 2002 (CN) 091200925

(51) Int. Cl. G01D 11/28

(52) U.S. Cl. 362/29; 362/216

(57) ABSTRACT

The present invention mainly relates to a liquid crystal display device which comprises a housing and a backlight module; wherein the housing comprises a frame and an opening formed at a central region of the housing, the opening defining an active area; the backlight module used in providing light source via the active area comprises at least one lamp distributed equally in regions defined by the frame and the active area. The at least one lamp comprising an even luminance portion and a dense luminance portion, wherein the even luminance portion is located in the region defined by the active area while the dense luminance portion is located in the region defined by the frame. Because the dense luminance portion is located outside the active area in the invention, the luminance uniformity in the active area is raised without complex treatments thereby.

### BACKGROUND OF THE INVENTION

1. Field of the invention

The present invention mainly relates to a liquid crystal display device, more particularly, to a backlight module used in a liquid crystal display device.

2. Description of the Related Art

Nowadays, liquid crystal display devices are applied much in personal computers, laptop computers and various kinds of communication equipment. However, liquid crystal itself does not emit light, and a backlight module must be applied to provide luminance to the liquid crystal display device. There are various kinds of backlight module used in the liquid crystal device. A direct under type backlight module usually comprises at least one linear lamp in parallel to each other disposed under a diffusing plate, and has advantages of light weight, high luminance and simple structure as compared with other kinds of backlight module.

Besides linear lamps applied in a direct under type backlight module, U-shaped lamps can also be applied (referring to Japan Patent NO. 7-272507 and 9-320320). Referring to FIG. 1, a liquid crystal display device 1 comprises a housing 11 and the housing 11 comprising a frame 111 and an opening 112 formed at a central region of the housing 11 to define an active area 12 and show specific data of a liquid crystal panel. A backlight module comprising at least one lamp 13 to provide light source to the active area 12, wherein each lamp 13 is in a U-shape formed by two parallel straight tube parts 131 and a bent tube part 132 all disposed in the active area 12, and comprises an electrode 133 at each end.

Comparing the U-shaped lamps with the linear lamps, uses and assemblies of the electrodes can be reduced. Besides, only a circuit board for connecting the electrodes 133 is needed to be disposed at one side of the liquid crystal display device, and the cost of manufacturing is reduced thereby. On the other hand, when using the U-shaped lamps 13, luminance of the bent tube part 132 nearby is much brighter than that of other regions to be uneven. In order to resolve the problem, a specially treated diffusing plate (not shown) is disposed above the lamps 13. Such treatment comprises printing or coating with specific materials in regions above the bent tube part 132 of the diffusing plate to make luminance of the bent tube part 132 nearby be the same as that of other parts after diffused by the diffusing plate. Such treatment is more difficult and the diffusing plate is damaged if unsuitable manipulated, and the cost of manufacturing rises also.

Therefore, the present invention is engaged in developing a novel and improved backlight module and a liquid crystal display device thereof to attain luminance uniformity and low cost.

### SUMMARY OF THE INVENTION

One objective of the present invention is to provide a liquid crystal display device which comprises a housing and a backlight module; wherein the housing comprises a frame and an opening formed at a central region of the housing, the opening defining an active area; the backlight module used in providing light source via the active area comprises at least one lamp distributed equally in regions defined by the frame and the active area. The at least one lamp comprising an even luminance portion and a dense luminance portion, wherein the even luminance portion is located in the region defined by the active area while the dense luminance portion is located in the region defined by the frame. Because the dense luminance portion is located outside the active area in the invention, the luminance uniformity in the active area is raised without complex treatments thereby.

The other objective of the present invention is to provide a backlight module used in a liquid crystal display device, the liquid crystal display device comprising a housing; wherein the housing comprises a frame and an opening formed at a central region of the housing, the opening defining an active area; the backlight module used in providing light source via the active area comprises at least one lamp distributed equally in regions defined by the frame and the active area. The at least one lamp comprising an even luminance portion and a dense luminance portion, wherein the even luminance portion is located in the region defined by the active area while the dense luminance portion is located in the region defined by the frame.

### BRIEF DESCRIPTION OF THE DRAWINGS

FIG. 1 illustrates a conventional housing and a direct under type backlight module of a liquid crystal display device;

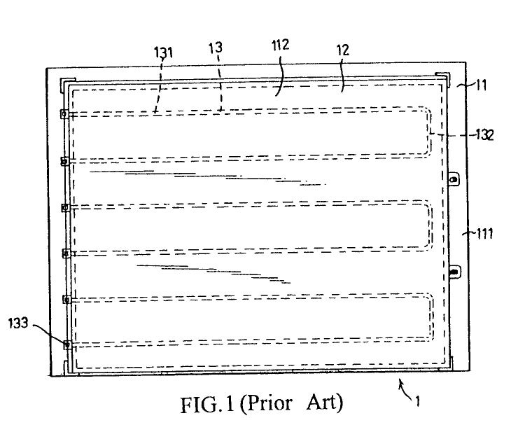

FIG. 2 illustrates a housing and a direct under type backlight module of a liquid crystal display device according to the first embodiment of the invention; and

FIG. 3 illustrates a housing and a direct under type backlight module of a liquid crystal display device according to the second embodiment of the invention.

### DETAILED DESCRIPTION OF THE INVENTION

The preferred embodiments in the invention are described below.

The First Embodiment

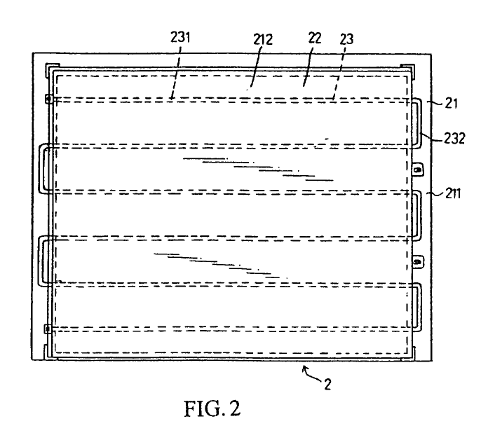

FIG. 2 illustrates a liquid crystal display device 2 comprising a housing 21 for receiving a backlight module comprising a frame 211 and an opening 212 formed at a central region of the housing, the opening to define an active area 22 to show specific data of a liquid crystal panel. The backlight module comprises at least one lamp 23 shaped by a serpentine tube comprising a plurality of parallel straight tube parts 231 which connect to adjacent ones by a bent tube part 232, more preferably, the straight tube parts 231 are generally paralleled to each other.

The present invention is characterized by disposing the lamps 23; wherein the straight tube part 231 forming an even luminance portion is almost located in the active area 22 while the bent tube part 232 forming a dense luminance portion is located outside of the active area 22. The bent tube part 232 is disposed in a region covered by the frame 211 to shelter light emitted by the bent tube part 232. As the reason, luminance of the active area 22 is almost emitted evenly by the straight tube parts 231 to be uniform. Therefore, a diffusing plate in the backlight module used in the present invention needs no special treatments and the costs and difficulties of manufacturing are significantly reduced.

The Second Embodiment

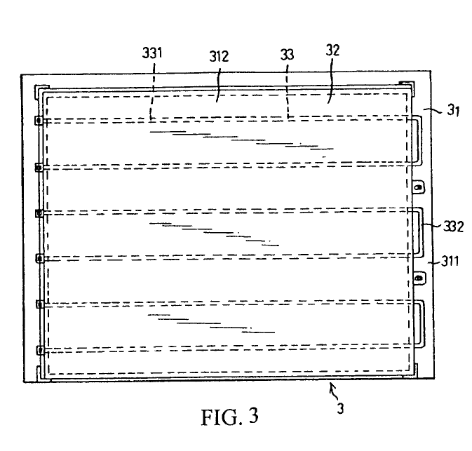

FIG. 3 illustrates a liquid crystal display device 3 similar to the liquid crystal display device 2 comprising an active area 32 defined by a housing 31 and backlight module having at least one lamp 33 to provide luminance. Each lamp 33 comprises two straight tube parts 331 almost in parallel to each other and a bent tube part 332 connecting therebetween to form a U-shape. The straight tube parts 331 are located in the active area 32 while the bent tube parts 332 are located outside of the active area 32. More preferably, the backlight module comprises three such lamps.

The liquid crystal display device of the present invention can be in any sizes, and luminance can be adjusted by changing positions, density and length of the lamp. Sizes and numbers of the lamp are not limited in the disclosure in the embodiments mentioned above. Liquid crystal display devices and backlight modules thereof having dense luminance portions sheltered by the frames are in the scope of the present invention.

As embodiments of the present invention have been illustrated and described, various modifications and improvements can be made by persons skilled in the art. The embodiments of the present invention are therefore described in an illustrative but not restrictive sense. It is intended that the present invention is not limited to the particular forms as illustrated, and that all the modifications not departing from the spirit and scope of the present invention are within the scope as defined in the appended claims.

What is claimed is:

1. A liquid crystal display device comprising:
a housing, comprising a frame and an opening formed at a central region of the housing, the opening defining an active area; and
a backlight module adapted to provide light source for the liquid crystal display device, in which the backlight module comprises at least one lamp disposed evenly in regions defined by the frame and the active area, and the at least one lamp comprises an even luminance portion and a dense luminance portion, wherein the even luminance portion is disposed in the region defined by the active area while the dense luminance portion is disposed in the region defined by the frame.

2. A liquid crystal display device according to claim 1, wherein the at least one lamp is shaped by a serpentine tube, which includes a plurality of straight tube parts forming the even luminance portion and a plurality of bent tube parts forming the dense luminance portion and connecting the straight tube parts sequentially.

3. A liquid crystal display device according to claim 2, wherein the straight tube parts are generally parallel to each other.

4. A liquid crystal display device according to claim 2, wherein the adjacent straight tube parts are equally spaced apart from each other.

5. A liquid crystal display device according to claim 1, comprising a plurality of U-shaped lamps, and each of the lamps comprising two straight tube parts and a bent tube part connecting therebetween, wherein the straight tube parts form the even luminance portion and the bent tube parts form the dense luminance portion.

6. A liquid crystal display device according to claim 5, wherein the straight tube parts are generally parallel to each other.

7. A liquid crystal display device according to claim 5, wherein the adjacent straight tube parts are equally spaced apart from each other.

8. A backlight module used in a liquid crystal display device, the liquid crystal display device comprising a housing, which comprises a frame and an opening formed at a central region of the housing, the opening defining an active area; the backlight module adapted to provide light source for the liquid crystal display device, in which the backlight module comprises at least one lamp disposed evenly in regions defined by the frame and the active area, and the at least one lamp comprises an even luminance portion and a dense luminance portion, wherein the even luminance portion is disposed in the region defined by the active area while the dense luminance portion is disposed in the region defined by the frame.

9. A backlight module according to claim 8, wherein the at least one lamp is shaped by a serpentine tube, which includes a plurality of straight tube parts forming the even luminance portion and a plurality of bent tube parts forming the dense luminance portion and connecting the straight tube parts sequentially.

10. A backlight module according to claim 9, wherein the straight tube parts are generally parallel to each other.

11. A backlight module according to claim 9, wherein the adjacent straight tube parts are equally spaced apart from each other.

12. A backlight module according to claim 8, comprising a plurality of U-shaped lamps, and each of the lamps comprising two straight tube parts and a bent tube part connecting therebetween, wherein the straight tube parts form the even luminance portion and the bent tube parts form the dense luminance portion.

13. A backlight module according to claim 12, wherein the straight tube parts are generally parallel to each other.

14. A backlight module according to claim 12, wherein the adjacent straight tube parts are equally spaced apart from each other.
